(19) United States
(12) Patent Application Publication
(10) Pub. No.: US 2011/0307492 A1
(43) Pub. Date: Dec. 15, 2011

(54) MULTI-REGION CLUSTER REPRESENTATION OF TABLES OF CONTENTS FOR A VOLUME

(75) Inventors: Dustin James Williams, Dexter, MI (US); Jens Nicholas Wessling, Ann Arbor, MI (US)

(73) Assignee: Rovi Technologies Corporation

(21) Appl. No.: 12/815,733

(22) Filed: Jun. 15, 2010

(51) Int. Cl. G06F 17/30

(52) U.S. Cl. 707/743; 707/E17.053

(57) ABSTRACT

A method and a system are provided for generating a multi-region cluster of tables of contents for a volume (e.g., album, a movie, a CD, a DVD, and/or a Blu-ray Disc). A multi-region cluster may be used to identify a volume efficiently despite natural variations found in different tables of contents for a volume. A multi-region cluster provides an effective representation of at least two tables of contents, preferably multiple tables of contents. A multi-region cluster is preferably substantially less data than the sum of all the tables of contents from user devices. The condensed data of a multi-region cluster allows data associated with the volume to be analyzed (e.g., searched, organized and/or located) in a substantially faster and more accurate manner. During a search process, the use of multi-region clusters tends to reduce the number of false positives. A false positive means the system incorrectly matches a table of contents to a volume (e.g., album, a movie, a CD, a DVD, and/or a Blu-ray Disc).

### FIELD OF THE INVENTION

The invention relates to tables of contents (TOCs) for a volume (e.g., album, a movie, a CD, a DVD, and/or a Blu-ray Disc). More particularly, the invention relates to representing tables of contents (TOC) for a volume by using a multi-region cluster.

### BACKGROUND

A conventional optical disc is typically recognized by reading table of contents (TOC) data from the disc. The TOC data may then be used to lookup, in a database, information about the contents of the optical disc. Examples of optical discs include a compact disc (CD), a digital video disc (DVD) and a Blu-ray Disc.

U.S. Pat. Nos. 6,230,192 and 6,330,593 (the '192 and '593 patents), which are hereby incorporated by reference, provide conventional examples of methods of identifying a disc and looking up disc information. The '192 and the '593 patents relate generally to delivering supplemental entertainment content to a user listening to a musical chapter. Using conventional techniques, an album identifier is computed for the album being played. The album identifier may be determined based on the number and lengths of tracks on the album. The album identifier is used to retrieve, from a database, information relating to the chapters played by the user.

### SUMMARY

A table of contents (TOC) for a volume (e.g., album) can be represented by the numerical durations of the individual chapters (e.g., tracks) of the volume. A TOC may be referred to as an identifier for the volume. Examples of a volume include an album, a book, magazine, publication, a movie, a CD, a DVD, and/or a Blu-ray Disc, among other things. Examples of a chapter include an audio track, a video track, a song, a book chapter, magazine chapter, publication chapter, a CD chapter, a DVD chapter and/or a Blu-ray Disc chapter, among other things.

A single volume may have multiple different tables of contents (TOCs) due to different pressings and/or different releases of the volume. In order to identify a volume by comparing TOCs, one must compare the TOC generated from a specific disc to all other known TOCs. Unfortunately, such comparing is typically a time consuming process. Conventional systems do not account for some of the obstacles related to identifying TOCs. The advent of digital media (e.g., audio, video and metadata) has caused the sheer size of data to become enormous. When a user device queries a server, the server may have to search through an enormous amount of data to provide a result for the query. Conventional methods of retrieving data are decreasing in efficiency because methods of searching data sets are not evolving as quickly as the data sets are getting bigger.

To reduce identification time and to increase identification accuracy, a system is provided for representing TOCs by using a multi-region cluster. Identification of a given volume may then be carried out by receiving the TOC for that volume, and then determining if TOC fits within the boundaries of the multi-region cluster.

In a first embodiment, a method is provided for generating a representation of tables of contents for a volume. The method may be carried out by at least one computer. The method comprises the following: receiving two or more tables of contents for a volume, wherein the tables of contents include a first table of contents and a second table of contents, wherein a table of contents includes a set of durations of chapters of a volume, and wherein a volume includes one or more chapters of media data, and wherein a chapter includes a media data block for playback; generating a first sub-cluster that includes at least the first table of contents; generating a second sub-cluster that includes at least the second table of contents, wherein the first sub-cluster and the second sub-cluster have substantially similar sizes and shapes; and defining a multi-region cluster that includes at least the first sub-cluster and the second sub-cluster, wherein the multi-region cluster represents at least the first table of contents and the second table of contents.

In a second embodiment, a system is provided for generating a representation of tables of contents for a volume. The system is configured for the following: receiving two or more tables of contents for a volume, wherein the tables of contents include a first table of contents and a second table of contents, wherein a table of contents includes a set of durations of chapters of a volume, and wherein a volume includes one or more chapters of media data, and wherein a chapter includes a media data block for playback; generating a first sub-cluster that includes at least the first table of contents; generating a second sub-cluster that includes at least the second table of contents, wherein the first sub-cluster and the second sub-cluster have substantially similar sizes and shapes; and defining a multi-region cluster that includes at least the first sub-cluster and the second sub-cluster, wherein the multi-region cluster represents at least the first table of contents and the second table of contents.

In a third embodiment, a computer readable medium comprises one or more instructions for generating a representation of tables of contents for a volume. The one or more instructions are configured for causing one or more processors to perform the following steps: receiving two or more tables of contents for a volume, wherein the tables of contents include a first table of contents and a second table of contents, wherein a table of contents includes a set of durations of chapters of a volume, and wherein a volume includes one or more chapters of media data, and wherein a chapter includes a media data block for playback; generating a first sub-cluster that includes at least the first table of contents; generating a second sub-cluster that includes at least the second table of contents, wherein the first sub-cluster and the second sub-cluster have substantially similar sizes and shapes; and defining a multi-region cluster that includes at least the first sub-cluster and the second sub-cluster, wherein the multi-region cluster represents at least the first table of contents and the second table of contents.

A multi-region cluster is preferably an effective representation of one or more tables of contents for a volume. A multi-region cluster allows data associated with a volume to be searched, organized, located and/or analyzed in a substantially more efficient manner.

The invention encompasses other embodiments configured as set forth above and with other features and alternatives. It should be appreciated that the invention can be implemented in numerous ways, including as a method, a process, an apparatus, a system or a device.

### BRIEF DESCRIPTION OF THE DRAWINGS

The invention will be readily understood by the following detailed description in conjunction with the accompanying drawings. To facilitate this description, like reference numerals designate like structural elements.

FIG. 1 is a block diagram of a system for generating a cluster of tables of contents (TOCs) for a volume, in accordance with some embodiments;

FIG. 2 is a conceptual diagram for illustrating distances between tables of contents (TOCs), in accordance with some embodiments;

FIG. 3 is a conceptual diagram for illustrating a size of a cluster, in accordance with some embodiments;

FIG. 4 is a conceptual diagram for illustrating shapes of clusters, in accordance with some embodiments;

FIG. 5 is a conceptual diagram illustrating a relationship between a first cluster and a second cluster, in accordance with some embodiments;

FIG. 6 is a graph showing a relationship between resolution (e.g., number of tables of contents per cluster size) and performance parameters for a matching process, in accordance with some embodiments;

FIG. 7 is a conceptual diagram of clusters, including a first multi-region cluster and a second multi-region cluster, in accordance with some embodiments;

FIG. 8 is flowchart of a method for generating a multi-region cluster of tables of contents (TOCs) for a volume (e.g., album, a movie, a CD, a DVD, and/or a Blu-ray Disc), in accordance with some embodiments; and

FIG. 9 is a block diagram of a general/special purpose computer system, in accordance with some embodiments.

### DETAILED DESCRIPTION

An invention is disclosed for a method and a system for generating a cluster of tables of contents (TOCs) for a volume (e.g., album, a movie, a CD, a DVD, and/or a Blu-ray Disc). Numerous specific details are set forth in order to provide a thorough understanding of the invention. It will be understood, however, to one skilled in the art, that the invention may be practiced with other specific details.

### DEFINITIONS

Some terms are defined below in alphabetical order for easy reference. These terms are not rigidly restricted to these definitions. A term may be further defined by its use in other sections of this description.

“Album” means a collection of tracks. An album is typically originally published by an established entity, such as a recording label (e.g., recording company, such as Warner or Universal).

“Audio Fingerprint” (e.g., “fingerprint”, “acoustic fingerprint”, and/or “digital fingerprint”) is a digital measure of certain properties of a waveform of an audio and/or visual signal (e.g., audio/visual data). An audio fingerprint is typically a fuzzy representation of an audio waveform generated by applying preferably a Fast Fourier Transform (FFT) to the frequency spectrum contained within the audio waveform. An audio fingerprint may be used to identify an audio sample and/or quickly locate similar items in an audio database. An audio fingerprint typically operates as an identifier for a particular item, such as, for example, an audio track, a song, a recording, an audio book, a CD, a DVD and/or a Blu-ray Disc. An audio fingerprint is an independent piece of data that is not affected by metadata. The company Rovi™ Corporation has databases that store over 100 million unique fingerprints for various audio samples. Practical uses of audio fingerprints include without limitation identifying songs, identifying recordings, identifying melodies, identifying tunes, identifying advertisements, monitoring radio broadcasts, monitoring peer-to-peer networks, managing sound effects libraries and/or identifying video files.

“Audio Fingerprinting” is the process of generating a fingerprint for an audio and/or visual waveform. U.S. Pat. No. 7,277,766 (the '766 patent), entitled “Method and System for Analyzing Digital Audio Files”, which is herein incorporated by reference, provides an example of an apparatus for audio fingerprinting an audio waveform. U.S. Pat. No. 7,451,078 (the '078 patent), entitled “Methods and Apparatus for Identifying Media Objects”, which is herein incorporated by reference, provides an example of an apparatus for generating an audio fingerprint of an audio chapter. U.S. patent application Ser. No. 12/456,177, by Jens Nicholas Wessling, entitled “Managing Metadata for Occurrences of a Recording”, which is herein incorporated by reference, provides an example of identifying metadata by storing an internal identifier (e.g., fingerprint) in the metadata.

“Blu-ray”, also known as Blu-ray Disc, means a disc format jointly developed by the Blu-ray Disc Association, and personal computer and media manufacturers (including Apple, Dell, Hitachi, HP, JVC, LG, Mitsubishi, Panasonic, Pioneer, Philips, Samsung, Sharp, Sony, TDK and Thomson). The format was developed to enable chapter, rewriting and playback of high-definition video (HD), as well as storing large amounts of data. The format offers more than five times the storage capacity of conventional DVDs and can hold 25 GB on a single-layer disc and 800 GB on a 20-layer disc. More layers and more storage capacity may be feasible as well. This extra capacity combined with the use of advanced audio and/or video codecs offers consumers an unprecedented HD experience. While current disc technologies, such as CD and DVD, rely on a red laser to read and write data, the Blu-ray format uses a blue-violet laser instead, hence the name Blu-ray. The benefit of using a blue-violet laser (605 nm) is that it has a shorter wavelength than a red laser (650 nm). A shorter wavelength makes it possible to focus the laser spot with greater precision. This added precision allows data to be packed more tightly and stored in less space. Thus, it is possible to fit substantially more data on a Blu-ray Disc even though a Blu-ray Disc may have the substantially similar physical dimensions as a traditional CD or DVD.

“Chapter” means a media data block (e.g., audio and/or visual data) for playback. A chapter preferably includes without limitation computer readable data generated from a waveform of a media data signal (e.g., audio and/or visual data signal). Examples of a chapter include without limitation a video track, an audio track, a book chapter, magazine chapter, a publication chapter, a CD chapter, a DVD chapter and/or a Blu-ray Disc chapter.

“Cluster” means a representation of several TOCs for a volume (e.g., album, a movie, a CD, a DVD, and/or a Blu-ray Disc). A cluster may be a multi-region cluster and/or a sub-cluster, among other types of clusters.

“Compact Disc” (CD) means a disc used to store digital data. A CD was originally developed for storing digital audio. Standard CDs have a diameter of 740 mm and can typically hold up to 80 minutes of audio. There is also the mini-CD, with diameters ranging from 60 to 80 mm. Mini-CDs are sometimes used for CD singles and typically store up to 24 minutes of audio. CD technology has been adapted and expanded to include without limitation data storage CD-ROM, write-once audio and data storage CD-R, rewritable media CD-RW, Super Audio CD (SACD), Video Compact Discs (VCD), Super Video Compact Discs (SVCD), Photo CD, Picture CD, Compact Disc Interactive (CD-i), and Enhanced CD. The wavelength used by standard CD lasers is 650 nm, and thus the light of a standard CD laser typically has a red color.

“Database” means a collection of data organized in such a way that a computer program may quickly select desired pieces of the data. A database is an electronic filing system. In some implementations, the term “database” may be used as shorthand for “database management system” and/or “database system”.

“Device” means software, hardware or a combination thereof. A device may sometimes be referred to as an apparatus. Examples of a device include without limitation a software application such as Microsoft Wore, a laptop computer, a database, a server, a display, a computer mouse, and a hard disk.

“Digital Video Disc” (DVD) means a disc used to store digital data. A DVD was originally developed for storing digital video and digital audio data. Most DVDs have the substantially similar physical dimensions as compact discs (CDs), but DVDs store more than six times as much data. There is also the mini-DVD, with diameters ranging from 60 to 80 mm. DVD technology has been adapted and expanded to include DVD-ROM, DVD-R, DVD+R, DVD-RW, DVD+RW and DVD-RAM. The wavelength used by standard DVD lasers is 650 nm, and thus the light of a standard DVD laser typically has a red color.

“False positive” means the system incorrectly matches a TOC with a volume (e.g., album, a movie, a CD, a DVD, and/or a Blu-ray Disc).

“False negative” means the system incorrectly fails to match a TOC with a volume (e.g., album, a movie, a CD, a DVD, and/or a Blu-ray Disc).

“Network” means a connection, which permits the transmission of data, between any two or more computers. A network may be any combination of networks, including without limitation the Internet, a local area network, a wide area network, a home media network, a wireless network, a cellular network and/or a network of networks.

“Pressing” (e.g., “disc pressing”) means producing a disc in a disc press from a master. A disc press preferably produces a disc for a reader that utilizes a laser beam having a bandwidth of about 780 nm for CD, about 650 nm for DVD, about 605 nm for Blu-ray Disc or another bandwidth as may be appropriate.

“Server” means a software application that provides services to other computer programs (and their users), in the same or other computer. A server may also refer to the physical computer that has been set aside to run a specific server application. For example, when the software Apache HTTP Server is used as the web server for a company's website, the computer running Apache is also called the web server. Server applications can be divided among server computers over an extreme range, depending upon the workload.

“Signature” means an identifying means that uniquely identifies an item, such as, for example, a volume, a track, a song, an album, a CD, a DVD and/or Blu-ray Disc, among other items. Examples of a signature include without limitation the following in a computer-readable format: an audio fingerprint, a portion of an audio fingerprint, a signature derived from an audio fingerprint, an audio signature, a video signature, a disc signature, a CD signature, a DVD signature, a Blu-ray Disc signature, a media signature, a high definition media signature, a human fingerprint, a human footprint, an animal fingerprint, an animal footprint, a handwritten signature, an eye print, a biometric signature, a retinal signature, a retinal scan, a DNA signature, a DNA profile, a genetic signature and/or a genetic profile, among other signatures. A signature may be any computer-readable string of characters that comports with any coding standard in any language. Examples of a coding standard include without limitation alphabet, alphanumeric, decimal, hexadecimal, binary, American Standard Code for Information Interchange (ASCII), Unicode and/or Universal Character Set (UCS). Certain signatures may not initially be computer-readable. For example, latent human fingerprints may be printed on a door knob in the physical world. A signature that is initially not computer-readable may be converted into a computer-readable signature by using any appropriate conversion technique. For example, a conversion technique for converting a latent human fingerprint into a computer-readable signature may include a ridge characteristics analysis.

“Software” means a computer program that is written in a programming language that may be used by one of ordinary skill in the art. The programming language chosen should be compatible with the computer by which the software application is to be executed and, in particular, with the operating system of that computer. Examples of suitable programming languages include without limitation Object Pascal, C, C++ and Java. Further, the functions of some embodiments, when described as a series of steps for a method, could be implemented as a series of software instructions for being operated by a processor, such that the embodiments could be implemented as software, hardware, or a combination thereof. Computer readable media are discussed in more detail in a separate section below.

“Song” means a musical composition. A song is typically recorded onto a track by a recording label (e.g., recording company). A song may have many different versions, for example, a radio version and an extended version.

“System” means a device and/or multiple coupled devices. A device is defined above.

“Table of Contents” (TOC) means the set of durations of chapters of a volume. U.S. Pat. No. 7,359,900 (the '900 patent), entitled “Digital Audio Track Set recognition System”, which is hereby incorporated by reference, provides an example of a method of using TOC data to identify a disc. The '900 patent also describes a method of using the identification of a disc to lookup metadata in a database and then sending that metadata to an end user.

“Track” means an audio and/or visual chapter. A track may be on a disc, such as, for example, a Blu-ray Disc, a CD or a DVD.

“User” means an operator of a computer. A user may include without limitation a consumer, an administrator, a client, and/or a client device in a marketplace of products and/or services.

“User device” (e.g., “client”, “client device”, and/or “user computer”) is a hardware system, a software operating system and/or one or more software application programs. A user device may refer to a single computer and/or to a network of interacting computers. A user device may be the client part of a client-server architecture. A user device typically relies on a server to perform some operations. Examples of a user device include without limitation a laptop computer, a CD player, a DVD player, a Blu-ray Disc player, a smart phone, a cell phone, a personal media device, a portable media player, an iPod™, a Zune™ Player, a palmtop computer, a mobile phone, an mp3 player, a digital audio recorder, a digital video recorder, an IBM-type personal computer (PC) having an operating system such as Microsoft Windows™, an Apple computer having an operating system such as MAC-OS, hardware having a JAVA-OS operating system, and/or a Sun Microsystems Workstation having a UNIX operating system.

“Volume” means a group of chapters of media data (e.g., audio data and/or visual data) for playback. A volume may be referred to as an album, a movie, a CD, a DVD, and/or a Blu-ray Disc, among other things.

“Volume copy” means a pressing, a release, a recording, a duplicate, a dubbed copy, a dub, a ripped copy and/or a rip of a volume (e.g., album, a movie, a CD, a DVD, and/or a Blu-ray Disc). Different copies of a same pressing are typically exact copies of a volume. However, a volume copy is not necessarily an exact copy of an original volume, and may be a substantially similar copy. A volume copy may be inexact for a number of reasons, including without limitation an imperfection in a copying process, different pressings having different settings, different volume copies having different encodings, different releases of the volume and other reasons. Accordingly, a volume copy may be the source for multiple copies that may be exact copies, substantially similar copies or unsubstantially similar copies. Different copies may be located on different devices, including without limitation different user devices, different mp3 players, different databases, different laptops, and so on. Each volume copy may be located on any appropriate storage medium, including without limitation floppy disk, mini disk, optical disc, CD, Blu-ray Disc, DVD, CD-ROM, micro-drive, magneto-optical disk, ROM, RAM, EPROM, EEPROM, DRAM, VRAM, flash memory, flash card, magnetic card, optical card, nanosystems, molecular memory integrated circuit, RAID, remote data storage/archive/warehousing, and/or any other type of storage device. Copies may be compiled, such as in a database or in a listing.

“Web browser” means any software program which can display text, graphics, or both, from Web pages on Web sites. Examples of a Web browser include without limitation Mozilla Firefox™ and Microsoft Internet Explorer™.

“Web page” means any documents written in mark-up language including without limitation HTML (hypertext mark-up language), VRML (virtual reality modeling language), dynamic HTML, XML (extended mark-up language) and/or related computer languages thereof, as well as to any collection of such documents reachable through one specific Internet address or at one specific Web site, or any document obtainable through a particular URL (Uniform Resource Locator).

“Web server” refers to a computer and/or another electronic device that is capable of serving at least one Web page to a Web browser. An example of a Web server is a Yahoo™ Web server.

“Web site” means at least one Web page, and more commonly a plurality of Web pages, virtually coupled to form a coherent group.

### I

### Overview of Architecture

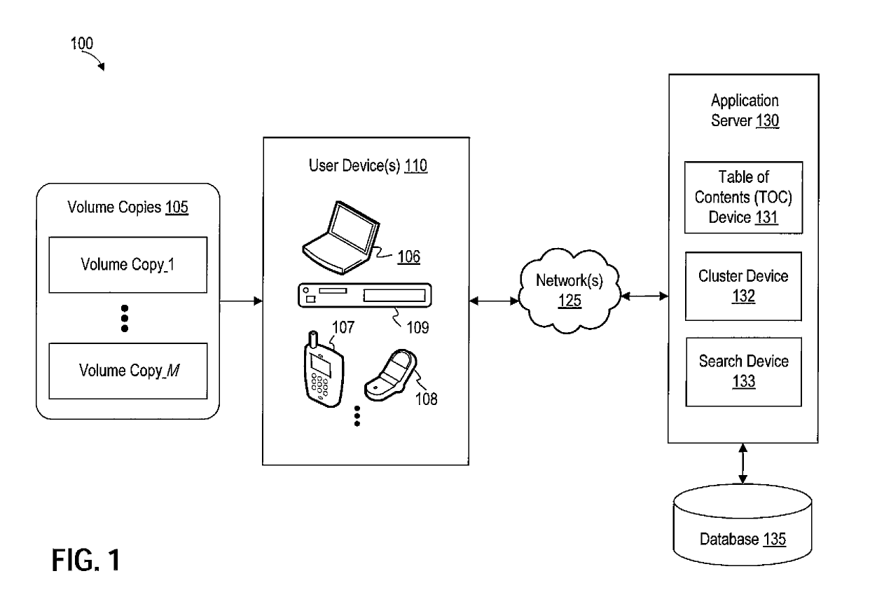

FIG. 1 is a block diagram of a system 100 for generating a cluster of tables of contents (TOCs) for a volume, in accordance with some embodiments. One or more networks 125 are coupled to an application server 130 and one or more user devices 110. The one or more networks 125 may include a variety of network types, such as, for example, the Internet, a local area network, a wide area network, a home media network, a wireless network, a cellular network and/or a network of networks.

The application server 130 preferably includes a table of contents (TOC) device 131, a cluster device 132 and/or a search device 133. The TOC device 131 is configured for generating a cluster representation for tables of contents of a volume. A TOC is a numerical representation of chapters for a volume (e.g., album, a movie, a CD, a DVD, and/or a Blu-ray Disc).

The cluster device 132 is configured for generating a multi-region cluster. Generating a multi-region cluster is described below in a separate section. The search device 133 is configured for searching data by using a multi-region cluster. Such a searching process is described below in a separate section.

The application server 130 is preferably coupled to a database 135. The database 135 may store, among other things, data collected and/or generated from one or more user devices 110. The database 135 preferably includes TOCs and/or multi-region clusters. The database 135 may also include data (e.g., metadata, audio data and/or visual data) associated with items, for example, albums, CDs, DVDs and/or Blu-ray Discs, among other things.

Examples of a user device 110 include without limitation a laptop computer 106, a standalone disc player 109, a smart phone 107 and a cell phone 108. A user device 110 is configured for receiving one or more volume copies 105. The volume copies 105 may include Volume Copy_1 through Volume Copy_M, where M is a positive integer.

A volume copy may be, for example, a CD that is inputted into the user device. A volume copy is preferably an exact copy of the original volume. For example, different volume copies of a same pressing are typically exact copies. However, a volume copy is not necessarily an exact copy of a volume, and may be a substantially similar copy. A volume copy may be an inexact copy for a number of reasons, including without limitation an imperfection in a copying process, different pressings having different settings, different volume copies having different encodings, different releases of the volume and other reasons. The volume copy may be released in a multitude of different ways and in different contexts. For example, a given volume copy may exist for an original CD, a greatest hits CD, a mix CD, a movie soundtrack, a DVD and/or a digital file, among other things.

Each user device 110 preferably includes hardware and/or software configured for communicating with the application server 130. For example, a user device may have an operating system with a graphical user interface (GUI) to access the Internet and is preferably equipped with World Wide Web (Web) browser software, such as Mozilla Firefox™, operable to read and send Hypertext Markup Language (HTML) forms from and to a Hypertext Transport Protocol (HTTP) server on the Web. A standalone disc player may have a built-in interface that enables the player to communicate with the application server 130 via the network 125, either directly or through another computer. For example, a disc player may have a data interface (e.g., an IDE interface or a USB interface) that enables the disc player to send and receive data from a laptop computer, which in turn is coupled to the network 125.

Likewise, the application server 130 preferably includes software and/or hardware for communicating with each user device 110. For example, the application server 130 may have HTTP compliant software, an operating system and common gateway interface (CGI) software for interfacing with a user device via the network 125. Alternatively, the application server 130 and a user device may run proprietary software that enables them to communicate via the network 125.

The system 100 may derive a TOC from each of the volume copies 105. For example, a user device 110 may generate a TOC based on audio data for a CD that is inputted into the user device 110, which may then send the TOC to the application server 130. As another example, the user device 110 may send audio data for a CD to the application server 130, which may then generate a TOC based on the audio data for the CD. Volume copies 105 that are not exact copies are likely to have different TOCs. For example, two volume copies 105 having one or more track durations that do not match will likely have different TOCs.

It will be readily appreciated that the schematic of FIG. 1 is for explanatory purposes, and that numerous variations are possible. For example, the TOC device 131, the cluster device 132 and the search device may not be within one application server 130, but rather may be in separate application servers or may be standalone devices. In another example, the application server 130 may be coupled to multiple Web servers. In yet another example, the system 100 may include a database (or system of databases) arranged in a configuration that is different than the database 135 depicted here. Alternatively, all of the operations of the system 100 may be carried out on one computer. Other configurations for system 100 exist as well.

### II

### Distances Between Tables of Contents for a Volume

A system for generating clusters of tables of contents (TOCs) is described below in a separate section. Before describing generating a cluster of TOCs, it is important to describe calculating a distance between two TOCs (e.g., two sets of chapters) for a volume.

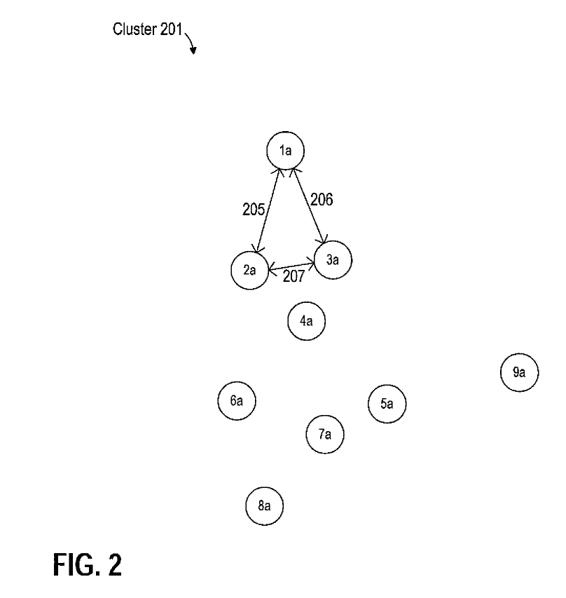

FIG. 2 is a conceptual diagram for illustrating distances between TOCs, in accordance with some embodiments. A cluster 201 is a representation of several TOCs for a volume (e.g., album, a movie, a CD, a DVD, and/or a Blu-ray Disc). The volume represented by the cluster 201 may be referred to as “volume A”. The TOCs in the cluster 201 include TOC 1a, TOC 2a, TOC 3a, TOC 4a, TOC 5a, TOC 6a, TOC 7a, TOC 8a and TOC 9a.

Any two TOCs preferably may be related to each other by a distance that indicates the level of closeness between the TOCs (e.g., durations of tracks, number of tracks, etc.). A distance 205 is a conceptual illustration of the mathematical distance between TOC 1a and TOC 2a. As illustrated in FIG. 2, each TOC in the cluster 201 has a location that is relative to the locations of the other TOCs in the cluster 201. For example, the distance between TOC 1a and TOC 2a is the distance 205. The distance between TOC 1a and TOC 3a is a distance 206. The distance between TOC 2a and TOC 3a is a distance 207. The other TOCs in FIG. 2 are similarly located by the distances between the TOCs.

There are many ways to calculate a distance between two TOCs. For example, each distance between two TOCs may be based on the following information: (1) durations of chapters in a TOC for the given volume and/or (2) the comparison of these durations to other durations of the chapters in another TOC for the given volume.

The following equation provides one of many examples of a formula for calculating a distance between two TOCs:

Distance=Σₖ₌₁^{N}|Duration_{Chapter k of TOC 1}−Duration_{Chapter k of TOC 2}| Equation 1.

Here, N is a positive integer representing the number of chapters (e.g. tracks). According to Equation 1, the distance between two TOCs is the sum of the absolute values of the time differences between the chapters of the two TOCs. For example, when determining an acceptable distance between a given CD and a catalog of CDs on a database, the system may compare the TOCs including the durations of the chapters for the respective CDs.

Note that a CD is used here as an example for explanatory purposes. A CD is a common storage medium on which to store a set of audio tracks. However, the system is not limited to comparing audio tracks on CD's only. The system may be applied when any two sets of chapters are to be compared against one another, no matter the particular storage medium. For example, the particular storage medium may be a DVD, a hard disk or a flash memory, among other storage mediums. Further, the chapters of music tracks are used as one example for explanatory purposes. However, the present system is not limited to comparing music tracks. The system may compare any two sets of chapters. For example, the system may compare two DVDs having audio/video chapters.

To further describe Equation 1 above, consider a comparison between TOC 1a and TOC 2a of FIG. 2. TOC 1a may be derived from a first CD. TOC 2a may be derived from a second CD. A goal is to determine the distance between the two TOCs (e.g., how related the CDs are). In this example, each TOC has 7 tracks. The system extracts from each TOC the time for each track. The comparison of the two TOCs is illustrated in the following Table:

TABLE 1
Comparison of Two Tables of Contents for a Volume

| Tracks | TOC 1a | TOC 2b | Distance |
|---|---|---|---|
| Number | (seconds) | (seconds) | \|Difference\| |
| 1 | 225 | 224 | 1 |
| 2 | 108 | 110 | 2 |
| 3 | 188 | 188 | 0 |
| 4 | 334 | 335 | 1 |
| 5 | 409 | 407 | 1 |
| 6 | 222 | 222 | 0 |
| 7 | 199 | 202 | 3 |
| | | Total | 8 |
| | | Distance | |

In Table 1, the “Track Number” column provides the track number being compared. The “TOC 1a” column provides the duration (e.g., seconds) for the particular track of TOC 1a. The “TOC 2a” column provides the duration (e.g., seconds) for the particular track of TOC 2a. The “Distance” column provides the absolute value of the time difference (e.g., seconds) between the corresponding tracks of TOC 1a and TOC 2a. A distance in Table 1 is one example of a difference between two compared tracks.

The “Total Distance” row at the bottom of Table 1 provides the sum of the distances (e.g., absolute values of time differences). Here, the sum of the distances is 8, which is the sum of the absolute values of the time differences. A lower total distance represents a closer distance between the two TOCs. A higher total distance represents a farther distance. The actual distances are not as important as the relative distances between the two TOCs as compared to other TOCs. A designer of the system may define these distances in many different ways. Table 1 above provides one example of how a designer may define the distances between TOCs. The other TOCs in FIG. 2, or elsewhere, may be compared in a manner that is similar to the way TOC 1a and TOC 2a are compared in Table 1.

In another embodiment, the system may be configured for calculating a distance between two TOCs by using another distance formula. For example, the system may be configured for calculating a distance by using the Pythagorean Theorem. A distance formula may be substantially more complex than the distance formula or Equation 1 above. The system may use other formulas as well.

In another embodiment, the system may be configured for calculating a distance between two TOCs by using other data besides track durations. For example, the system may use at least one of the following: total number of chapters (e.g., tracks) of a TOC, average chapter time of a TOC, median chapter time of a TOC, standard deviation of chapter times of a TOC, and recording quality of audio data associated with a TOC. The system may use other data as well.

In another embodiment, distances (e.g., scores) may be weighted or un-weighted, as described in U.S. Patent Publication No. 2010/0124335 (the '335 patent Publication), entitled “Scoring a Match of Two Audio Tracks Sets Using Track Time Probability Distribution”, which is herein incorporated by reference, provides a system for scoring a match of two TOCs (e.g., two audio tracks sets) by using a track time probability distribution. Such a scoring system may be used for calculating a distance between two TOCs for a volume.

### Size and Shape of a Cluster of Tables of Contents for a Volume

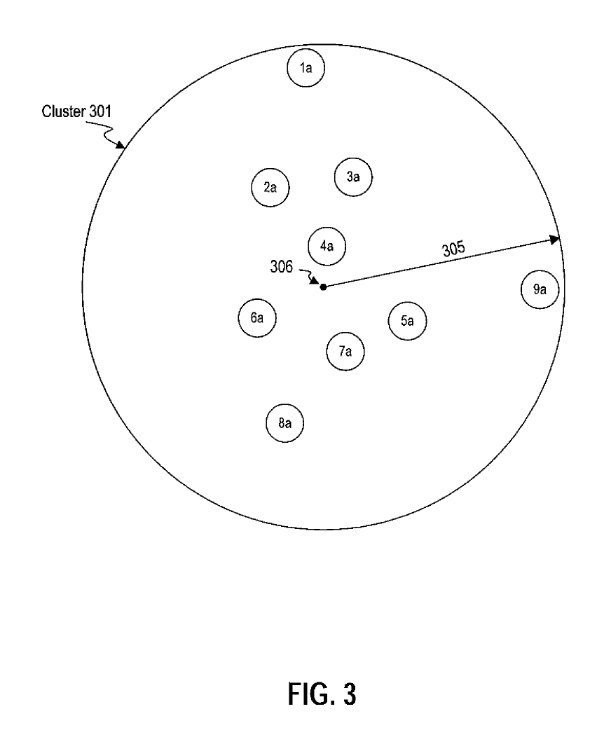

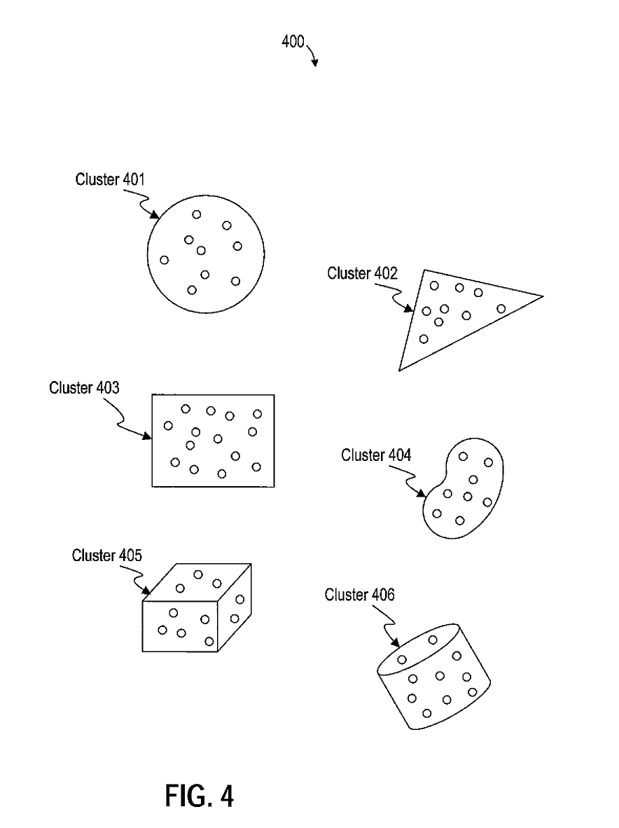

FIG. 3 is a conceptual diagram for illustrating a size of a cluster 301, in accordance with some embodiments. A cluster may have a size that allows the cluster to include two or more TOCs within the cluster boundary. The cluster 301 is in a shape of a circle for explanatory purposes. However, a cluster may have any shape as discussed below with reference to FIG. 4.

Referring to FIG. 3, the cluster 301 has a radius 305, which illustrates the size of the cluster 301. The radius 305 extends from the cluster center 306 to the cluster boundary. The cluster 301 has a size that allows the cluster 301 to be representative of several TOCs for a volume (e.g., album, a movie, a CD, a DVD, and/or a Blu-ray Disc). The TOCs in the cluster 301 include TOC 1a, TOC 2a, TOC 3a, TOC 4a, TOC 5a, TOC 6a, TOC 7a, TOC 8a and TOC 9a.

Even though chapter durations of TOCs in a cluster may differ, the system is configured for treating the TOCs in the same cluster as referring to the same volume (e.g., album, a movie, a CD, a DVD, and/or a Blu-ray Disc), until additional data proves otherwise. For example, the chapter durations of TOC 1a may differ from the chapter durations of TOC 2a. However, these two TOCs are within the boundaries of the same cluster and, therefore, the system is configured for treating these two TOCs as referring to the same volume (e.g., album, a movie, a CD, a DVD, and/or a Blu-ray Disc).

FIG. 4 is a conceptual diagram for illustrating shapes of clusters 400, in accordance with some embodiments. A cluster may have an N-dimensional shape, where N is a positive integer. The shape of a cluster may be any form. For example, cluster 401 has a shape of an ellipse (e.g., circle) or a sphere. A cluster 402 has a shape of a polygon (e.g., triangle). A cluster 403 has a shape of another polygon (e.g., square). A cluster 404 has a nebulous shape. A cluster 405 has a shape of a polygonal prism (e.g., box). A cluster 406 has a shape of an elliptical prism (e.g., cylinder).

The clusters 400 of FIG. 4 are illustrated in two dimensions and/or three dimensions for explanatory purposes. The number of dimensions of a cluster may increase as the distances between TOCs become more complex. As shown in Table 1, some examples of factors that may affect distances between TOCs include the following: chapter numbers (e.g., Track 1, Track 2, etc.), chapter durations, and total number of chapters for a TOC.

In another embodiment, a cluster may have a shape that is not illustrated in FIG. 4. Clusters may also have as many dimensions as necessary, or as desired, to describe the distances between TOCs of a cluster and/or a volume (e.g., album, a movie, a CD, a DVD, and/or a Blu-ray Disc). As indicated above, a cluster may have N dimensions, where N is a positive integer. Note that a cluster having more than three dimensions is difficult to illustrate in a black and white drawing on flat paper. However, the system may be configured to generate a cluster having more than three dimensions.

### III

### Cluster Representation of Tables of Contents for a Volume

Using clusters to represent data is described in the U.S. patent application Ser. No. 12/456,194 (the '194 patent application), entitled “Generating a Representative Sub-Signature of a Cluster of Signatures by Using Weighted Sampling”, which is herein incorporated by reference.

A table of contents (TOC) is a numerical representation of chapters from a volume. The same volume (e.g., album, a movie, a CD, a DVD, and/or a Blu-ray Disc), can have multiple TOCs due to different pressings and releases. In order to identify a volume by comparing TOCs, the system is configured to compare a TOC generated from a volume copy to all other known TOCs for that volume. A comparison process between a given TOC and all other known TOCs for a volume can be unduly time consuming. Accordingly, it may be more desirable to compare a given TOC to a cluster that represents multiple TOCs.

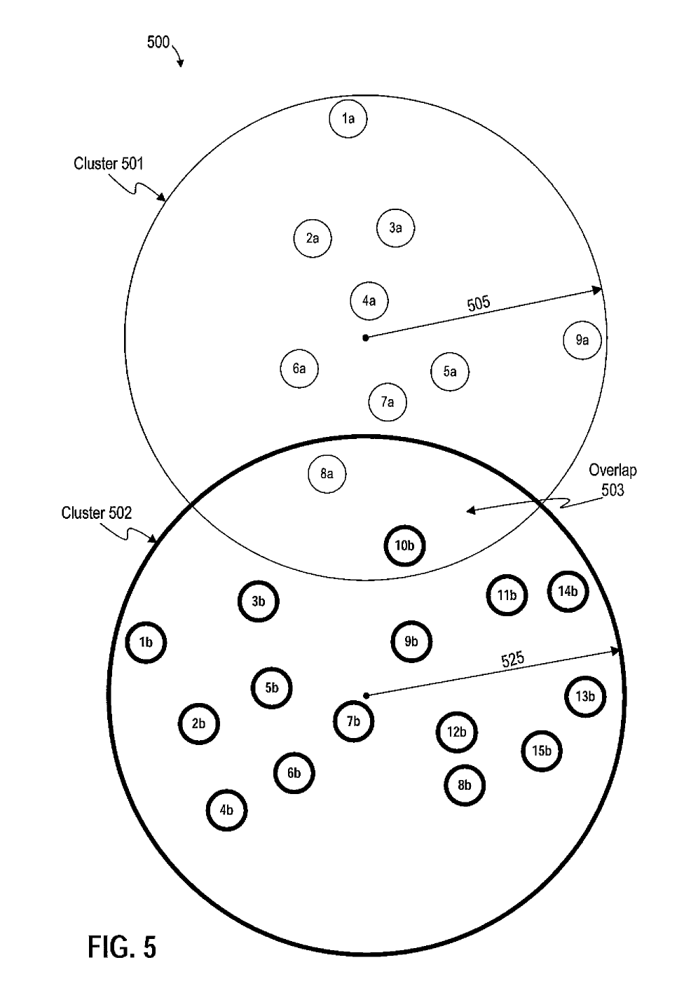

FIG. 5 is a conceptual diagram illustrating a relationship 500 between a first cluster 501 and a second cluster 502, in accordance with some embodiments. The cluster 501 and the cluster 502 are each in a shape of a circle for explanatory purposes. However, a cluster may have any shape, as discussed above with reference to FIG. 4.

The cluster 501 has a radius 505, which illustrates the size of the cluster 501 for explanatory purposes. The radius 505 extends from the cluster center to the cluster boundary. The cluster 501 has a size that allows the cluster 501 to be representative of several TOCs for a volume (e.g., album, a movie, a CD, a DVD, and/or a Blu-ray Disc). Each TOO in the cluster 501 has a location that is relative to the other locations of the other TOCs in the cluster 501. The TOCs in the cluster 501 include TOC 1a, TOC 2a, TOC 3a, TOC 4a, TOC 5a, TOC 6a, TOC 7a, TOC 8a and TOC 9a.

The cluster 502 has a radius 525, which illustrates the size of the cluster 502. The radius 525 extends from the cluster center to the cluster boundary. The cluster 502 has a size that allows the cluster 502 to be representative of several TOCs for a volume (e.g., album, a movie, a CD, a DVD, and/or a Blu-ray Disc). Each TOC in the cluster 502 has a location that is relative to the other locations of the other TOCs in the cluster 502. The TOCs in the cluster 502 include TOC 1b, TOC 2b, TOC 3b, TOC 4b, TOC 5b, TOC 5b, TOC 7b, TOC 8b, TOC 9b, TOC 10b, TOC 11b, TOC 12b, TOC 13b, TOC 14b and TOC 15b.

The cluster 501 and the Cluster 502 cross each other at an overlap 503. The overlap 503 includes two TOCs, including TOC 8a and TOC 10b. Accordingly, the overlap 503 leads to two false positive, including one false positive for the cluster 501 and one false positive for cluster 502. The false positive for cluster 501 includes TOC 10b because this TOC belongs to cluster 502. The false positive for cluster 502 includes TOC 8a because this TOC belongs to cluster 501.

A comparison process using one large cluster can be problematic due to false positives. When performing media recognition, minimizing false positives is highly important. The system may decrease false positives by increasing cluster resolution. Cluster resolution means the number of TOCs per cluster size. Each cluster has a particular resolution within the N-dimensional space of the cluster.

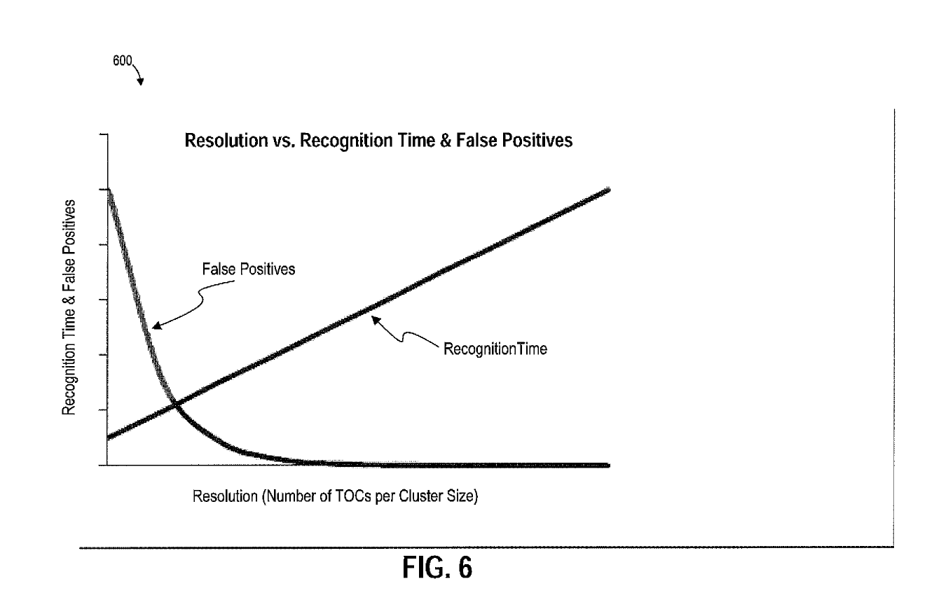

FIG. 6 is a graph 600 showing a relationship between resolution (e.g., number of TOCs per cluster size) and performance parameters for a matching process, in accordance with some embodiments. As shown in FIG. 6, as the system increases the resolution of a cluster, the number of false positives decreases during the match process. As mentioned above with reference to FIG. 5, false positive means the system incorrectly matches a TOC with a volume (e.g., album, a movie, a CD, a DVD, and/or a Blu-ray Disc). When performing media recognition, minimizing false positives is highly important. A fewer number of false positives translates into increased accuracy during the match process. However, as the system increases the resolution of the cluster, the system undergoes increased lookup time during the match process. The system is preferably configured for balancing accuracy of the match process and speed of the match process.

### Multi-Region Cluster Representation of Tables of Contents for a Volume

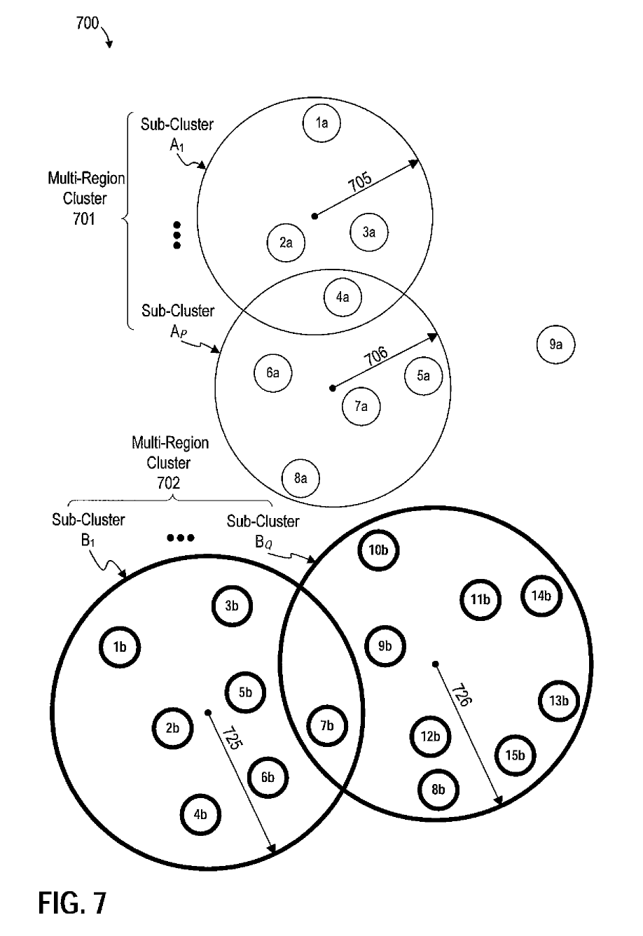

To increase identification accuracy and reduce false positives, the system is configured for generating a multi-region cluster (e.g., multiple sub-clusters) in order to optimize (e.g., increase) cluster resolution, as described below with reference to FIG. 7. As described above, cluster resolution means the number of TOCs per cluster size. Each multi-cluster has a particular resolution within the N-dimensional space of the cluster.

FIG. 7 is a conceptual diagram of clusters 700, including a first multi-region cluster 701 and a second multi-region cluster 702, in accordance with some embodiments. A multi-region cluster includes a combination of two or more sub-clusters. A sub-cluster means a cluster that is a subset of a multi-region cluster. For example, the number of sub-clusters in the multi-region cluster 701 is P, where P is a positive integer greater than 1. As illustrated in FIG. 7, the multi-region cluster 701 includes a sub-cluster A₁ through a sub-cluster A_{P}.

The cluster 701 has an overall size that allows the cluster 701 to be representative of several TOCs for a volume (e.g., album, a movie, a CD, a DVD, and/or a Blu-ray Disc). Each TOC in the cluster 701 has a location that is relative to the other locations of the other TOCs in the cluster 701. The TOCs in the cluster 701 include TOC 1a, TOC 2a, TOC 3a, TOC 4a, TOC 5a, TOC 6a, TOC 7a and TOC 8a.

Sizes of sub-clusters of the same cluster are preferably substantially similar. In the example of FIG. 7, radius lengths of sub-clusters of the same cluster are substantially similar. A radius of a sub-cluster indicates the size of the sub-cluster, as described above with reference to FIG. 3. Each radius extends from a sub-cluster center to the sub-cluster boundary. For example, the sub-cluster A₁ has a radius 705. The sub-cluster A_{P} has a radius 706. The length of the radius 705 is preferably substantially similar to the length of the radius 706.

Shapes of sub-clusters of the same cluster are preferably substantially similar. For example, each sub-cluster in the cluster 701 is in a shape of a circle for explanatory purposes. Note, however, that a sub-cluster may have any shape and may have multiple dimensions, as discussed above with reference to FIG. 4. For example, the cluster 701, which includes a combination of the sub-cluster A₁ through the sub-cluster A_{P}, has an overall shape that is not a circle.

As another example of a multi-region cluster, the multi-region cluster 702 includes Q sub-clusters, where Q is a positive integer greater than 1. As illustrated in FIG. 7, the multi-region cluster 702 includes a sub-cluster B₁ through a sub-cluster B_{Q}.

The cluster 702 has an overall size that allows the cluster 702 to be representative of several TOCs for a volume (e.g., album, a movie, a CD, a DVD, and/or a Blu-ray Disc). Each TOC in the cluster 702 has a location that is relative to the other locations of the other TOCs in the cluster 702. The TOCs in the cluster 702 include TOC 1b, TOC 2b, TOC 3b, TOC 4b, TOC 5b, TOC 6b, TOC 7b, TOC 8b, TOC 9b, TOC 10b, TOC 11b, TOC 12b, TOC 13b, TOC 14b and TOC 15b.

As indicated above, sizes of sub-clusters of the same cluster are preferably substantially similar. In the example of FIG. 7, radius lengths of sub-clusters of the same cluster are preferably substantially similar. A radius of a sub-cluster indicates the size of the sub-cluster, as described above with reference to FIG. 3. Each radius extends from a sub-cluster center to a sub-cluster boundary. For example, the sub-cluster B₁ has a radius 725. The sub-cluster B_{Q} has a radius 726. The length of the radius 725 is preferably substantially similar to the length of the radius 726.

As indicated above, shapes of sub-clusters of the same cluster are preferably substantially similar. For example, each sub-cluster in the cluster 702 is in a shape of a circle for explanatory purposes. Note, however, that a sub-cluster may have any shape and may have multiple dimensions, as discussed above with reference to FIG. 4. For example, the cluster 702, which includes a combination of the sub-cluster B₁ through the sub-cluster B_{Q}, has an overall shape that is not a circle.

For a single cluster, the system is configured for using as many sub-clusters as necessary to represent sufficiently the TOCs for a volume (e.g., album, a movie, a CD, a DVD, and/or a Blu-ray Disc). However, the system preferably uses the least, or a minimal, number of sub-clusters required to represent sufficiently the TOCs for a volume. Accordingly, the system is configured for selecting a size (e.g., radius) and a shape for sub-clusters such that the following things are accomplished: (1) the system sufficiently represents the TOCs for a volume, and (2) the system uses the least, or a minimal, number of sub-clusters.

Sub-clusters of a single multi-region cluster may or may not overlap. For example, the sub-cluster A₁ overlaps with the sub-cluster A_{P}. The TOC 4a belongs to both the sub-cluster A₁ overlaps and the sub-cluster A_{P}. However, the system is not limited to defining a multi-region cluster that includes overlapping sub-clusters. A multi-region cluster may include sub-clusters that are separate and that do not overlap.

Advantageously, the use of a multi-region cluster tends to reduce the number of false positives by optimizing (e.g., reducing) resolution of the multi-region cluster. As indicated above with reference to FIG. 5, a false positive means the system incorrectly matches a TOC to a volume (e.g., album, a movie, a CD, a DVD, and/or a Blu-ray Disc). As shown in FIG. 7, neither the cluster 701 nor the cluster 702 has a false positive. This accuracy is an improvement to the system of FIG. 5, which illustrates a technique that does not involve multi-region clusters.

Note, however, that the use of multi-region clusters may increase the number of false negatives. As shown in FIG. 7, the TOC 9a is a false negative. When performing a search by using the cluster 701, the system may incorrectly fail to match the TOC 9a with the volume that the cluster 701 represents. Searching by using multi-region clusters is described below in a separate section.

### Overview of Method for Generating a Multi-Region Cluster of Tables of Contents

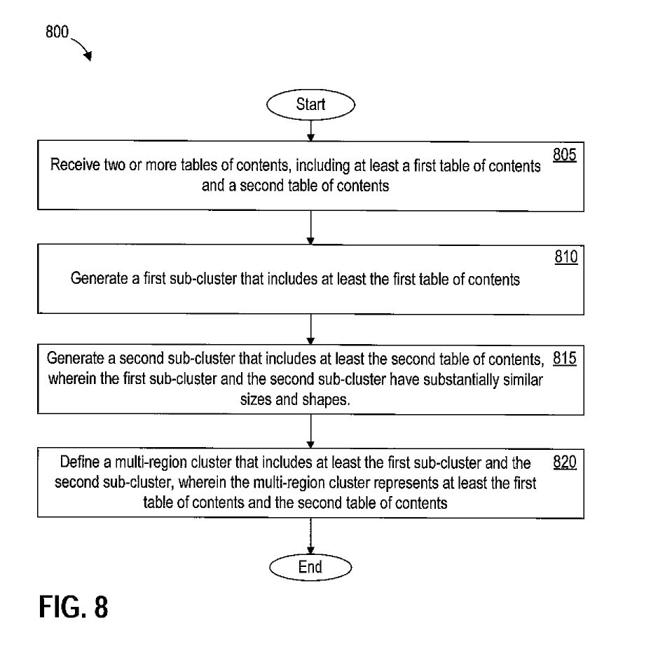

FIG. 8 is flowchart of a method 800 for generating a multi-region cluster of tables of contents (TOCs) for a volume (e.g., album, a movie, a CD, a DVD, and/or a Blu-ray Disc), in accordance with some embodiments. The steps of the method 800 are preferably carried out by one or more devices of the system 100 of FIG. 1.

The method 800 starts in a step 805 where the system receives two or more tables of contents for a volume, including a first table of contents and a second table of contents. A volume includes one or more chapters of media data (e.g., audio data and/or visual data). A table of contents includes a set of durations of chapters. A chapter includes a media data block (e.g., audio and/or visual data) for playback.

The method 800 then moves to a step 810 where the system generates a first sub-cluster that includes the first table of contents. Sub-clusters are described above with reference to FIG. 7.

The method 800 then proceeds to a step 815 where the system generates a second sub-cluster that includes at least the second table of contents. The first sub-cluster and the second sub-cluster have substantially similar sizes and shapes.

Next, in a step 820, the system defines a multi-region cluster that includes the first sub-cluster and the second sub-cluster. The multi-region cluster represents at least the first table of contents and the second table of contents. Multi-region clusters are described above with reference to FIG. 7.

Note that the method 800 may include other details that are not discussed in this method overview. Other details are discussed with reference to the appropriate figures and may be a part of the method 800, depending on the embodiment.

### IV

### Searching Data by Using a Multi-Region Cluster of Tables of Contents

Tables of contents (TOCs) may be represented by a multi-region cluster, as described above with reference to FIG. 7. During a search, identifying (e.g., recognizing) a media item (e.g., CD) may be more efficient if the system searches a multi-region cluster, instead of individual tables of contents.

The system may use a multi-region cluster of tables of contents to facilitate searching for information related to a volume (e.g., album). The multi-region cluster may serve as a representation of the volume and/or a representation of two or more tables of contents. The multi-region cluster includes preferably less data than the sum of all the tables of contents from various user devices. As explained further below, searching for data related to the volume is substantially more efficient with use of a multi-region cluster.

Identifying a volume may involve preliminary operations of generating a multi-region cluster, as discussed above with reference to other figures. U.S. patent application Ser. Nos. 12/378,841 and 12/378,840, entitled “Recognizing a Disc”, which are herein incorporated by reference, provide examples of methods for identifying (e.g., recognizing) a disc, among other items.

Referring to FIG. 1, the search device 133 is configured for searching for volumes by using clusters of tables of contents. An exemplary generation of a multi-region cluster is discussed above with reference to FIG. 7. The search device 133 is configured for searching, organizing and/or analyzing the database 135. The database 135 may include without limitation one or more clusters of tables of contents. The search device 133 is configured for searching, organizing and/or analyzing the multi-region clusters in the database 135 in an efficient manner.

Some or all software and data necessary for searching and managing multi-region clusters may be stored on the application server 130 and/or a user device 110. For example, a user device 110 may contain a subset or a complete set of the data available in the database 135 that is coupled to the application server 130. The user device 110 may be loaded with data from a CD-ROM (not shown). The user device 110 may store data on a hard disk of the user device. Alternatively, the user device 110 may download data to the user device 110 from the database 135 via the one or more networks 125. Other configurations exist as well.

The search device 133 is configured for searching, organizing and/or analyzing the multi-region clusters in the database 135 in an efficient manner. Other examples of different types of searchable data exist as well. U.S. patent application Ser. No. 12/565,626 (the '626 patent application), which is referenced above, provides an example of a system for navigating and searching through synthetic tables of contents on a database. U.S. Patent Publication No. 2007/0288478 (the '478 patent Publication), entitled “Method and System for Media Navigation”, is hereby incorporated by reference. The '478 patent Publication provides an example of a method for navigating and searching through media on a database.

A user device 110 may access the database 135 via a network 125. For example, the user may insert a disc while the user device 110 is coupled to the network 125. The disc may be, for example, a Blu-ray Disc. The user device 125 may send to the search device 133 a query about the inserted disc. The application server 130 performs a search based on the query. The search device 133 determines if the queried disc matches a disc in the database 135 by comparing the queried disc to multi-region clusters in the database 135. If the queried disc matches a multi-region cluster (e.g., the queried disc falls within the boundaries of a cluster), then the search device 133 retrieves from the database 135 the metadata associated with the matching CD. The application server 130 then sends this metadata to the user device 110. After receiving a response from the application server 130, the user device 110 may display the returned metadata or a “no match” message, as appropriate. The user device 110 and/or the application server 130 may take other actions as well.

Alternatively, a user device 110 may perform a more comprehensive download of data from the database 135 to a user device 110. While the user device 110 is offline, the user device 110 may then provide relevant data according to a multi-region cluster in the user device 110. For example, a user may insert a disc while the user device 110 is offline from the network 125. The disc may be, for example, a Blu-ray Disc. The user device 110 may then provide the relevant data by locating the appropriate multi-region cluster in the user device 110. The user device 110 may also retrieve the relevant data from the user device 110 upon receiving a user's manual request.

### V

### Computer Readable Medium Implementation

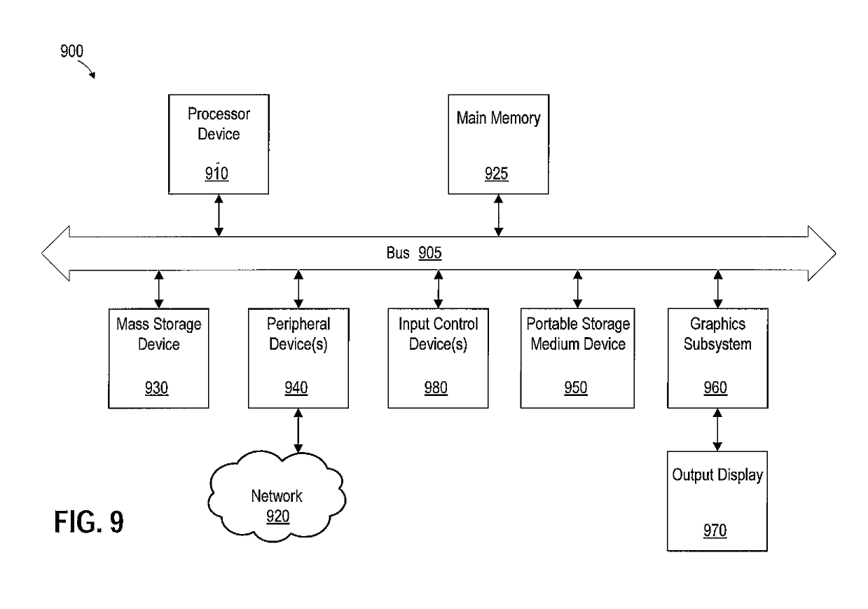

FIG. 9 is a block diagram of a general/special purpose computer system 900, in accordance with some embodiments. The computer system 900 may be, for example, a user device, a user computer, a client computer and/or a server computer, among other things. Examples of a user device include without limitation a Blu-ray Disc player, a personal media device, a portable media player, an iPod™, a Zune™ Player, a laptop computer, a palmtop computer, a smart phone, a cell phone, a mobile phone, an mp3 player, a digital audio recorder, a digital video recorder, a CD player, a DVD player, an IBM-type personal computer (PC) having an operating system such as Microsoft Windows™ an Apple™ computer having an operating system such as MAC-OS, hardware having a JAVA-OS operating system, and a Sun Microsystems Workstation having a UNIX operating system.

The computer system 900 preferably includes without limitation a processor device 910, a main memory 925, and an interconnect bus 905. The processor device 910 may include without limitation a single microprocessor, or may include a plurality of microprocessors for configuring the computer system 900 as a multi processor system. The main memory 925 stores, among other things, instructions and/or data for execution by the processor device 910. If the system for generating a multi-region cluster of tables of contents is partially implemented in software, the main memory 925 stores the executable code when in operation. The main memory 925 may include banks of dynamic random access memory (DRAM), as well as cache memory.

The computer system 900 may further include a mass storage device 930, peripheral device(s) 940, portable storage medium device(s) 950, input control device(s) 980, a graphics subsystem 960, and/or an output display 970. For explanatory purposes, all components in the computer system 900 are shown in FIG. 9 as being coupled via the bus 905. However, the computer system 900 is not so limited. Devices of the computer system 900 may be coupled through one or more data transport means. For example, the processor device 910 and/or the main memory 925 may be coupled via a local microprocessor bus. The mass storage device 930, peripheral device(s) 940, portable storage medium device(s) 950, and/or graphics subsystem 960 may be coupled via one or more input/output (I/O) buses. The mass storage device 940 is preferably a nonvolatile storage device for storing data and/or instructions for use by the processor device 910. The mass storage device 930, which may be implemented, for example, with a magnetic disk drive or an optical disk drive. In a software embodiment, the mass storage device 930 is preferably configured for loading contents of the mass storage device 930 into the main memory 925.

The portable storage medium device 950 operates in conjunction with a nonvolatile portable storage medium, such as, for example, a compact disc read only memory (CD ROM), to input and output data and code to and from the computer system 900. In some embodiments, the software for generating a cluster of tables of contents may be stored on a portable storage medium, and may be inputted into the computer system 900 via the portable storage medium device 950. The peripheral device(s) 940 may include any type of computer support device, such as, for example, an input/output (I/O) interface configured to add additional functionality to the computer system 900. For example, the peripheral device(s) 940 may include a network interface card for interfacing the computer system 900 with a network 920.

The input control device(s) 980 provide a portion of the user interface for a user of the computer system 900. The input control device(s) 980 may include a keypad and/or a cursor control device. The keypad may be configured for inputting alphanumeric and/or other key information. The cursor control device may include, for example, a mouse, a trackball, a stylus, and/or cursor direction keys. In order to display textual and graphical information, the computer system 900 preferably includes the graphics subsystem 960 and the output display 970. The output display 970 may include a cathode ray tube (CRT) display and/or a liquid crystal display (LCD). The graphics subsystem 960 receives textual and graphical information, and processes the information for output to the output display 970.

Each component of the computer system 900 may represent a broad category of a computer component of a general/special purpose computer. Components of the computer system 900 are not limited to the specific implementations provided here.

Portions of the invention may be conveniently implemented by using a conventional general purpose computer, a specialized digital computer and/or a microprocessor programmed according to the teachings of the present disclosure, as will be apparent to those skilled in the computer art. Appropriate software coding may readily be prepared by skilled programmers based on the teachings of the present disclosure. Some embodiments may also be implemented by the preparation of application-specific integrated circuits or by interconnecting an appropriate network of conventional component circuits.

Some embodiments include a computer program product. The computer program product may be a storage medium/media having instructions stored thereon/therein which can be used to control, or cause, a computer to perform any of the processes of the invention. The storage medium may include without limitation floppy disk, mini disk, optical disc, Blu-ray Disc, DVD, CD-ROM, micro-drive, magneto-optical disk, ROM, RAM, EPROM, EEPROM, DRAM, VRAM, flash memory, flash card, magnetic card, optical card, nanosystems, molecular memory integrated circuit, RAID, remote data storage/archive/warehousing, and/or any other type of device suitable for storing instructions and/or data.

Stored on any one of the computer readable medium/media, some implementations include software for controlling both the hardware of the general/special computer or microprocessor, and for enabling the computer or microprocessor to interact with a human user or other mechanism utilizing the results of the invention. Such software may include without limitation device drivers, operating systems, and user applications. Ultimately, such computer readable media further includes software for performing aspects of the invention, as described above.

Included in the programming/software of the general/special purpose computer or microprocessor are software modules for implementing the processes described above. The processes described above may include without limitation the following: receiving two or more tables of contents for a volume, wherein the tables of contents include a first table of contents and a second table of contents; generating a first sub-cluster that includes at least the first table of contents; generating a second sub-cluster that includes at least the second table of contents, wherein the first sub-cluster and the second sub-cluster have substantially similar sizes and shapes; and defining a multi-region cluster that includes at least the first sub-cluster and the second sub-cluster, wherein the multi-region cluster represents at least the first table of contents and the second table of contents.

### Advantages

The system described above is configured for generating a multi-region cluster for tables of contents (TOCs) for a volume. A multi-region cluster provides an effective representation of at least two TOCs, preferably multiple TOCs. A multi-region cluster is preferably substantially less data than the sum of all the TOCs from user devices. The condensed data of a multi-region cluster allows data associated with the volume to be analyzed (e.g., searched, organized and/or located) in a substantially faster and more accurate manner. During a search process, the use of multi-region clusters tends to reduce the number of false positives. A false positive means the system incorrectly matches a TOC to a volume (e.g., album, a movie, a CD, a DVD, and/or a Blu-ray Disc).

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method for generating a representation of tables of contents for a volume, wherein the method is configured for being carried out by at least one computer, the method comprising:
receiving two or more tables of contents for a volume, wherein the tables of contents include a first table of contents and a second table of contents, wherein a table of contents includes a set of durations of chapters of a volume, and wherein a volume includes one or more chapters of media data, and wherein a chapter includes a media data block for playback;
generating a first sub-cluster that includes at least the first table of contents;
generating a second sub-cluster that includes at least the second table of contents, wherein the first sub-cluster and the second sub-cluster have substantially similar sizes and shapes; and
defining a multi-region cluster that includes at least the first sub-cluster and the second sub-cluster, wherein the multi-region cluster represents at least the first table of contents and the second table of contents.

2. The method of claim 1, wherein the two or more tables of contents are separated by distances, and wherein each distance indicates a level of closeness between two tables of contents.

3. The method of claim 2, wherein a distance between two tables of contents is calculated by using at least one of:
a distance formula;
a Pythagorean Theorem; and
a sum of absolute values of time differences between chapters of the two tables of contents.

4. The method of claim 1, wherein the first sub-cluster and the second sub-cluster have substantially similar sizes.

5. The method of claim 1, wherein a size of the first sub-cluster is smaller than a size of the multi-cluster, and wherein a size of the second sub-cluster is smaller than the size of the multi-cluster.

6. The method of claim 1, wherein the first sub-cluster and the second sub-cluster have N-dimensional shapes that are substantially similar, and wherein N is a positive integer.

7. The method of claim 1, wherein the multi-region cluster has an N-dimensional shape, wherein N is a positive integer, and wherein N is a number of dimensions necessary to describe the distances between tables of contents in the multi-cluster.

8. The method of claim 1, further comprising at least one of:
increasing a resolution of the multi-region cluster, wherein the resolution is a number of tables of contents per a size of the multi-region cluster; and
decreasing a size of the multi-region cluster by decreasing sizes of sub-clusters of the multi-region cluster.

9. The method of claim 1, further comprising at least one of:
performing a search operation by using the multi-region cluster; and
reducing a number of false positives by increasing a resolution of the multi-region cluster, wherein the resolution is a number of tables of contents per a size of the multi-region cluster, and wherein a false positive is an incorrect match of a table of contents with a volume.

10. The method of claim 1, wherein the first sub-cluster does not overlap the second sub-cluster.

11. A system for generating a representation of tables of contents for a volume, wherein the system is configured for:
receiving two or more tables of contents for a volume, wherein the tables of contents include a first table of contents and a second table of contents, wherein a table of contents includes a set of durations of chapters of a volume, and wherein a volume includes one or more chapters of media data, and wherein a chapter includes a media data block for playback;
generating a first sub-cluster that includes at least the first table of contents;
generating a second sub-cluster that includes at least the second table of contents, wherein the first sub-cluster and the second sub-cluster have substantially similar sizes and shapes; and
defining a multi-region cluster that includes at least the first sub-cluster and the second sub-cluster, wherein the multi-region cluster represents at least the first table of contents and the second table of contents.

12. The system of claim 11, wherein the two or more tables of contents are separated by distances, and wherein each distance indicates a level of closeness between two tables of contents.

13. The system of claim 12, wherein a distance between two tables of contents is calculated by using at least one of:
a distance formula;
a Pythagorean Theorem; and
a sum of absolute values of time differences between chapters of the two tables of contents.

14. The system of claim 11, wherein the first sub-cluster and the second sub-cluster have substantially similar sizes.

15. The system of claim 11, wherein a size of the first sub-cluster is smaller than a size of the multi-cluster, and wherein a size of the second sub-cluster is smaller than the size of the multi-cluster.

16. The system of claim 11, wherein the first sub-cluster and the second sub-cluster have N-dimensional shapes that are substantially similar, and wherein N is a positive integer.

17. The system of claim 11, wherein the multi-region cluster has an N-dimensional shape, wherein N is a positive integer, and wherein N is a number of dimensions necessary to describe the distances between tables of contents in the multi-cluster.

18. The system of claim 11, wherein the system is further configured for at least one of:
increasing a resolution of the multi-region cluster, wherein the resolution is a number of tables of contents per a size of the multi-region cluster; and
decreasing a size of the multi-region cluster by decreasing sizes of sub-clusters of the multi-region cluster.

19. The system of claim 11, wherein the system is further configured for at least one of:
performing a search operation by using the multi-region cluster; and
reducing a number of false positives by increasing a resolution of the multi-region cluster, wherein the resolution is a number of tables of contents per a size of the multi-region cluster, and wherein a false positive is an incorrect match of a table of contents with a volume.

20. The system of claim 11, wherein the first sub-cluster does not overlap the second sub-cluster.

21. A computer readable medium comprises one or more instructions for generating a representation of tables of contents for a volume, wherein the one or more instructions are configured for causing one or more processors to perform the steps of:
receiving two or more tables of contents for a volume, wherein the tables of contents include a first table of contents and a second table of contents, wherein a table of contents includes a set of durations of chapters of a volume, and wherein a volume includes one or more chapters of media data, and wherein a chapter includes a media data block for playback;
generating a first sub-cluster that includes at least the first table of contents;
generating a second sub-cluster that includes at least the second table of contents, wherein the first sub-cluster and the second sub-cluster have substantially similar sizes and shapes; and
defining a multi-region cluster that includes at least the first sub-cluster and the second sub-cluster, wherein the multi-region cluster represents at least the first table of contents and the second table of contents.
